(19) United States
(12) Patent Application Publication
(10) Pub. No.: US 2025/0001992 A1
(43) Pub. Date: Jan. 2, 2025

(54) PARKING BRAKE DEVICE WITH IMPROVED COMMAND

(71) Applicants: HITACHI ASTEMO FRANCE, DRANCY (FR); HITACHI ASTEMO HEILBRONN GMBH, HEILBRONN (DE)

(72) Inventors: Julien SASSO, CHAMPS SUR MARNE (FR); Weiqiao WANG, PARIS (FR); Alex PATRAO CARQUEIJO, PANTIN (FR); Maxime DEMANDRE, STUTTGART (DE)

(21) Appl. No.: 18/682,536

(22) PCT Filed: Jun. 29, 2022
(86) PCT No.: PCT/FR2022/051303

§ 371 Date: Feb. 9, 2024

(30) Foreign Application Priority Data
Aug. 13, 2021 (FR) FR2108685

(51) Int. Cl. B60T 13/74; B60T 7/10; F16D 65/18; F16D 121/24; H02K 7/06

(52) U.S. Cl. CPC B60T 13/746; B60T 7/10; F16D 65/18; H02K 7/06; B60T 2220/04; B60T 2270/82; F16D 2121/24

(57) ABSTRACT

An electromechanical parking brake command is aborted with no predefined plan being completed if the driver initiates an opposite command when the vehicle is stationary. The plan normally implemented for the second command is itself shortened as a result. The brake is therefore quickly returned to its original state, and a command sent inadvertently is corrected quickly.

The present invention relates to a parking brake with improved command.

Modern parking brakes are often electromechanical, controlled by an integrated geared motor, according to predefined strategies and under the control of an electric motor control unit. The commands can be triggered either by the driver of the vehicle or automatically according to driving parameters, if the parking brake is also used as an emergency brake during journeys of the vehicle.

Whilst the vehicle is at a standstill, the driver may trigger a command to apply the parking brake by mistake or may change their mind immediately after, which is all the more plausible given that the controller of such electromechanical parking brakes is often a button that when pressed alternately commands the brake to be applied or released, without it being possible to tell directly what the applied command will be. But when a command has been transmitted to the control unit, it is carried out up to completion before a following command, which cancels the first one, is considered.

The prior art comprises document US2013/096796 A1. The braking method described therein involves replacing an ordinary strategy by a limited brake application strategy in certain circumstances, in particular when a temperature sensor of the brake is faulty. The method then comprises checks for a “crazy mode”, in which the brake control button is constantly pressed. Each time the button is pressed, a count value is decreased in an index. If this value reaches zero, the limited brake application strategy replaces the normal brake application strategy. The function of this part of the method is to ensure safety by preventing excessive brake applications, but not to quickly correct incorrect button commands. Indeed, a brake application strategy in progress during “crazy mode” is not interrupted, but replaced by another strategy, and only when a value in an index has dropped to zero, possibly after a large number of successive commands. Finally, it should be noted that the change of strategy only applies to applying the brake, but not to releasing it, which is still carried out as normal.

The aim of the invention is to avoid the wasted time caused by incorrect or unintentional commands of the parking brake, by enabling the effect of these incorrect commands to be cancelled more quickly when they are corrected immediately.

According to the invention, the brake application strategy is then no longer completed, but is interrupted as soon as the command has been cancelled by pressing the controller again.

Interruptions to electromechanical brake command strategies are unusual, especially if they interrupt an already commanded brake application. The particular case of a parking brake is different, since the vehicle is at a standstill or at low speed when the commands originating from the vehicle are taken into account, and the dangers associated with driving are therefore absent.

According to a general definition, the invention relates to a motor control unit of an electromechanical motor vehicle parking brake, supplying brake application and release commands to an electric motor of an actuator of the brake, said commands being governed by predefined strategies in response to inputs given to a controller by an occupant of the vehicle, characterized in that it is designed, if a second action follows a first action on the controller while a first command, triggered by the first action, is still in progress, to start a second command according to the second action immediately, interrupting the first command.

In particular, the invention is applied if the first action is a command to release the brake.

The controller is advantageously a button (or a similar device with a single actuation state), the commands of which are alternately, by design, brake application and brake release commands.

The invention can be applied in particular to systems where the strategies impose application commands which, uninterrupted, produce a given final brake application force, and release commands which, uninterrupted, produce brake actuator strokes of a given length.

So if the first command is an application command, it is advantageous that the second command has an imposed duration similar to the first command.

Another aspect of the invention is a corresponding motor vehicle braking device; this device comprising the parking brake, the brake actuator, the electric motor controlling the actuator, the motor control unit supplying brake application and release commands to the electric motor, said commands being governed by predefined strategies, and the controller according to the above.

Another aspect is a motor vehicle comprising this braking device, the brake possibly in particular being fitted to a non-driven wheel of the vehicle.

The different aspects, features and advantages of the invention will become apparent from the detailed description of a specific embodiment thereof, provided purely for illustrative purposes, which is now given by means of the following figures:

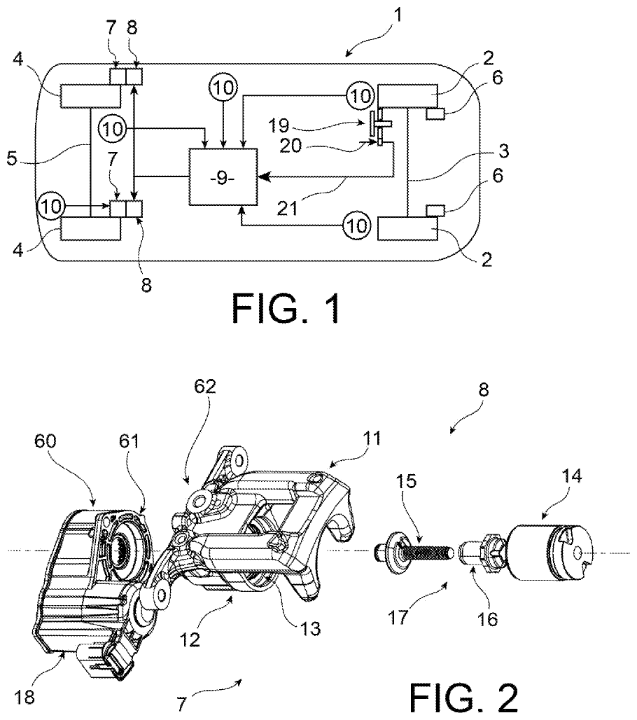

FIG. 1 schematically shows a motor vehicle with its parking brake system and the means to control it;

FIG. 2 shows an electromechanical parking brake;

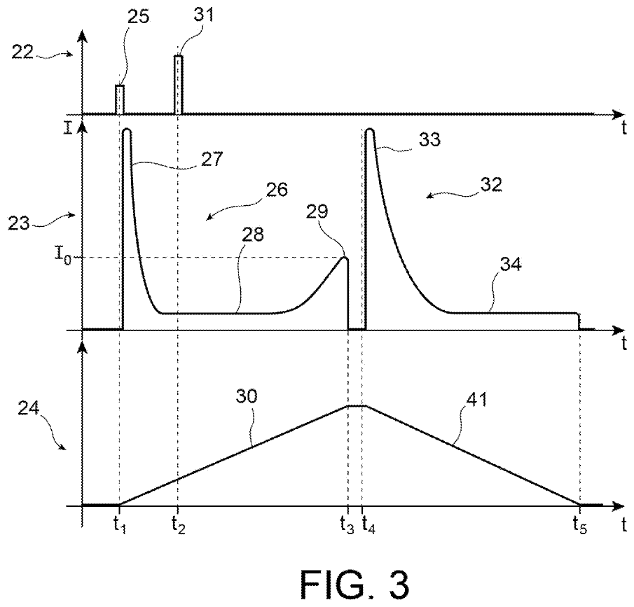

FIG. 3 shows a standard existing strategy for controlling the brake;

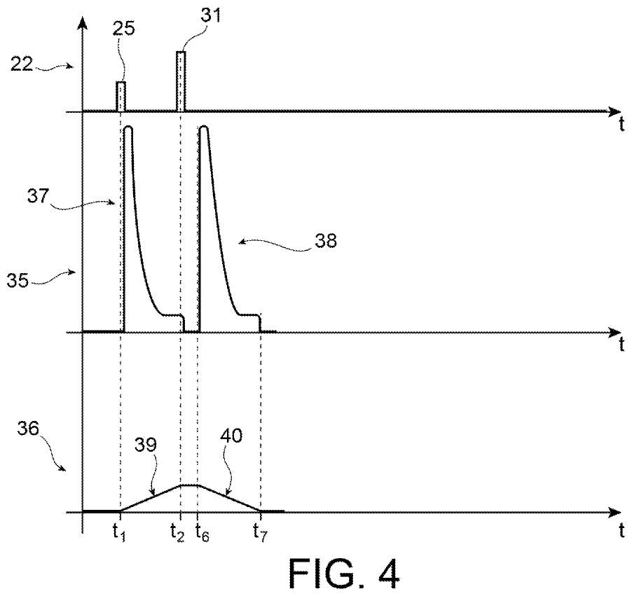

FIG. 4 shows a different strategy in accordance with the invention.

FIG. 1 shows a car 1 having two driven and steered front wheels 2 on a front axle 3, and two non-driven and non-steered rear wheels 4 on a rear axle 5. Each of the front wheels 2 has a main service brake 6 here actuated directly by the driver by depressing a brake pedal, and each of the rear wheels 4 has an electromechanical brake 7 (simply called “brake” hereinafter) having an actuator 8 controlled by a same motor control unit 9. Each of the brakes 7 functions as a parking brake that the driver of the vehicle switches from a released state to an applied state to stop the car 1, and vice-versa to allow it to move. Sat behind a dashboard 19, the driver presses a controller such as a button 20 to switch between the applied state and the released state of the brakes 7, and a corresponding electrical impulse is sent to the central control unit 9 via a transmission line 21.

In various vehicle models, the brakes 7 can also be used as service brakes at the same time as the main brakes 6 when the driver carries out braking, or as emergency brakes to complement the action of the main brakes 6; the motor control unit 9 then uses the indications of sensors 10 mounted on the vehicle which measure various driving parameters, without the driver intervening. However, these additional possibilities for controlling the brakes 7 do not influence the invention, which is applied when the vehicle is stationary, or almost stationary.

FIG. 2 schematically shows a known exemplary embodiment of the brake 7, based on an exploded view. The brake 7 comprises a caliper 11 joined to a cylindrical housing 12. It also comprises a geared motor 60, one flange 61 of which is joined to a flange 62 at the rear face of the housing 12 by screws (not shown here). The geared motor 60 includes an electric motor 18 and gears for reducing the speed of rotation of said electric motor 18. The housing 12 comprises a hydraulic cavity 13 called a cylinder, open towards the front (at the right-hand side of FIG. 2) and in which a piston 14 supporting a mobile pad (not shown) slides. Braking is achieved by sliding the piston 14 forwards to bring the mobile pad closer to a fixed pad located at the front end of the caliper 11 and clamp a disc of the rear wheel 4 between these pads. This movement of the piston 14 is achieved, when the brake 7 works as a service brake, by applying hydraulic pressure in the hydraulic cavity 13 while the vehicle is being driven: this pressure is exerted on the rear face of the piston 41, pushing it forwards. If, however, the brake 7 is controlled as a parking brake or emergency brake, braking is achieved by using the electric motor 18 according to strategies imposed by the motor control unit 9. The electric motor 18 sets the gears of the geared motor 60 in motion, which turns a screw 15 which extends into the hydraulic cavity 13. The screw 15 engages with a nut 16 against which a rear face of the piston 14 abuts. The rotations of the screw 15 are converted into translations of the nut 16 and the piston 14, which moves as a function of the time the electric motor 18 is activated. The actuator 8 in question here comprises in particular the geared motor 60 and therefore its electric motor 18, and the system 17 composed of the screw 15 and the nut 16. The invention could be applied to other vehicles and brakes than these.

When the brake 7 is moved by the actuator 8, the latter is controlled by the motor control unit 9 according to predefined strategies taught to it. If the driver wanting to park or leave switches between the released state and the applied state, standard strategies involve establishing a given brake application force 7 for application, and a given stroke of the actuator 8 or piston 14 for release. In both cases, these strategies are always carried out until the application force has been reached, or the release stroke is completed. This is still true in the document quoted above, even if the application force can be reduced compared to the normal force.

Reference is now made to FIG. 3. An upper diagram 22 shows the pressure exerted by the driver on the button 20, a middle diagram 23 illustrates the intensity of the electric current I flowing through the electric motor 18 to control it, and a lower diagram 24 shows the stroke accomplished by the piston 14: these three diagrams 22, 23 and 24 are all given as a function of time t on the x axis.

The driver gives an initial impulse 25 at a time t₁, which triggers a first command 26, in this case applying the brake 7. The motor control unit 9 closes an electrical circuit on which the electric motor and a battery, or another means of supplying electricity are placed, which sets the electric motor 18 in motion. The current in the electrical circuit adjusts as a function of the application force. Three periods can be distinguished in the change in the current I supplied: a first peak period 27, which corresponds to backlash compensation in the actuator 8, during which the current I is high, a second much longer plateau period 28 during which the current I is conversely much lower and approximately constant and which corresponds to an idle stroke of the actuator 8, and a third period of growth 29 during which the current I increases regularly and which corresponds to effective and progressive application of the brake 7. The current I is therefore approximately proportional to the application force. The command stops at a time t₃, when a given stopping current threshold I₀, corresponding to a desired application force, has been reached. The actuator 8 moves at constant speed during this command 26, as shown by the corresponding part, or first part 30, of the lower diagram 24, the slope of which is uniform.

If a second impulse 31 is given by the driver at the time t₂ very shortly after t₁, a second command 32, relative to releasing the brake 7, is applied to the electric motor 18. It comprises a first peak period 33, with a gradual decline, which corresponds both to the backlash compensation in the actuator 8 and progressive release of the brake 7, then a second plateau period 34 where the current I is low and uniform, and which corresponds to an idle stroke of the actuator 8, in order to return it approximately to its initial state prior to the first impulse 25, which is shown by the second part 41 of the lower diagram 24, with a uniform downward slope, and more or less symmetrical to the first part 30. The second command 32 starts at a time t₄ shortly after t₃, and it finishes at a later time t₅. As the standard strategy imposes a final force or an invariable stroke length, the duration (t₅−t₄) of the second command 32 is similar to that (t₃−t₁) of the first command 26, and the second command 32 only starts when the first command 26 is completed, which means that the starting time t₄ is substantially later than that of the second impulse 31. This response time is unpleasantly long for the driver if they have made an unintentional or incorrect command to park the vehicle that they would like to immediately correct.

That is why it is envisaged, in accordance with the invention, to modify the strategy for controlling the brake 7 according to FIG. 4. Once again, there are three diagrams as a function of time t, including the upper diagram showing the impulses provided by the driver, which is identical to that in FIG. 3 and therefore has the reference number 22 again, a middle diagram 35, and a lower diagram 36 similar to the same diagrams 23 and 24 in FIG. 3.

The first command 37 applied according to the invention at the time t₁ of the first impulse 25 starts as with the previous first command 26, but it is now interrupted at the time t₂ when the second impulse 26 intended to cancel the previous one is issued. The second command 38 can then start at a time to immediately following, corresponding only to a response time of the system. It is envisaged that it too is curtailed, and stops at a time t₇ after a duration (t₇−t₆) similar to the duration that was itself curtailed (t₂−t₁) of the first command 37. This ensures that the actuator 8 and brake 7 return to a virtually unchanging release state. The lower diagram 36 again has, as a consequence of this, two symmetrical parts 39 and 40, which show the return of the system to its initial state from the time t₇, i.e. a lot quicker than when applying the standard strategy.

If the first command that the conductor interrupts by a second opposite command is a release command, a similar time saving is achieved, as the first command can be interrupted without delay, and the second command, which starts immediately after, is curtailed too as the stopping current threshold I₀ is reached more quickly.

One advantage of the invention is therefore an acceleration in the commands of the parking brake 7; other advantages are saving electrical energy, and decreased wear on the brake 7 thanks to the reduced amplitude of movement.

The invention is only applied when circumstances allow, i.e. when the vehicle is stationary or almost stationary, and parking is feasible. The function of the brake 7 is not modified in other circumstances.

### NOMENCLATURE

1 Car
2 Front wheels
3 Front axle
4 Rear wheels
5 Rear axle
6 Main brake
7 Electromechanical brake
8 Actuator
9 Motor control unit
10 Sensors
11 Calliper
12 Housing
13 Hydraulic cavity
14 Piston
15 Screw
16 Nut
17 Screw-nut system
18 Electric motor
19 Dashboard
20 Button
21 Transmission line
22, 23, 24 Diagrams
25 First impulse
26 First command
27 Peak
28 Plateau
29 Period of growth
30 First part of the stroke
31 Second impulse
32 Second command
33 Peak
34 Plateau
35, 36 Diagrams
37 First command
38 Second command
39, 40 Parts of the stroke
60 Geared motor
61 Flange
62 Flange
41 Second part of the stroke
I Intensity of the electric current
I₀ Command stopping intensity threshold
t Time
t₁ to t₇ Command times

What is claimed is:

1. A motor control unit of an electromechanical motor vehicle parking brake, supplying brake application and release commands to an electric motor of an actuator of the brake, said commands being governed by predefined strategies in response to inputs given to a controller by an occupant of the vehicle, wherein the motor control unit is designed, if a second action follows a first action on the controller while a first command, triggered by the first action, is still in progress, to start a second command according to the second action immediately, interrupting the first command.

2. The motor control unit according to claim 1, wherein the first action is a brake release command.

3. The motor control unit according to claim 1, wherein the controller is a button, and the commands are alternately brake application and brake release commands.

4. The motor control unit according to claim 1, wherein the strategies impose application commands which, uninterrupted, produce a given final brake application force, and release commands which, uninterrupted, produce brake actuator strokes of a given length.

5. The motor control unit according to claim 4, wherein if the first command is an application command, the second command has an imposed duration similar to the first command.

6. A motor vehicle braking device, comprising the parking brake, the brake actuator, the electric motor controlling the actuator, the motor control unit supplying brake application and release commands to the electric motor, said commands being governed by predefined strategies, and the controller according to claim 1.

7. A motor vehicle, comprising the braking device according to claim 6.

8. The motor vehicle according to claim 7, wherein the brake is fitted to a non-driven wheel of the vehicle.
